(19) United States
(12) Patent Application Publication
(10) Pub. No.: US 2010/0028254 A1
(43) Pub. Date: Feb. 4, 2010

(54) ZINC OXIDE PARTICLE, ZINC OXIDE PARTICLE FILM, AND PROCESSES FOR PRODUCING THESE

(75) Inventors: Yoshitake Masuda, Aichi (JP); Kazumi Kato, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: National Institute of Adv. Ind. Science and Tech., Chiyoda-ku, Tokyo (JP)

(21) Appl. No.: 12/442,615

(22) PCT Filed: Sep. 26, 2007
(86) PCT No.: PCT/JP2007/068727

§ 371 Date: Mar. 24, 2009

(30) Foreign Application Priority Data
Sep. 27, 2006 (JP) 2006-263562

(51) Int. Cl. C01G 9/02

(52) U.S. Cl. 423/622

(57) ABSTRACT

The present invention provides zinc oxide particles having a large specific surface area, and a zinc oxide composite material, and processes for producing these, and the invention is zinc oxide particles formed by crystal growth into a multi-needle shape and having a larger specific surface area than hexagonal columnar particles; to a zinc oxide composite material comprising the zinc-containing thin film and the zinc oxide particles; to processes for producing the zinc oxide particles and the composite material, and an advantage of the present invention is that a larger specific surface area can be obtained than with hexagonal columnar particles, and a particle film of a specified thickness with fewer grain boundaries can be formed, thereby achieving less reduction in dielectric constant due to grain boundaries.

### TECHNICAL FIELD

This invention relates to zinc oxide particles, a zinc oxide particle film, and processes for producing these, and more particularly relates to zinc oxide particles and a zinc oxide particle film that have a large specific surface area and can be utilized in gas sensors, dye-sensitized solar cells, and the like, and to processes for producing these.

### BACKGROUND ART

Zinc oxide (ZnO) has become an attractive device material aimed at sensors for various kinds of gas, such as CO, NH₃, NO₂, H₂S, H₂, ethanol, SF₆, C₄H₁₀, and gasoline, and dye-sensitized solar cells. The sensitivity of these devices is largely dependent upon the specific surface area of the substrate substance, so there has been a need for the development of zinc oxide particles (ZnO particles) and zinc oxide particle films (ZnO films) that have a large specific surface area.

As seen in the following prior art publications (Non-Patent Documents 1 and 2), for example, there have been a number of recent attempts at forming a zinc oxide particle film with a large specific surface area by controlling the form of the zinc oxide particles. In these research examples related to sensors or solar cells, there have been reports on hexagonal columnar ZnO rods and wires. These are based on the fact that ZnO has a hexagonal crystal structure, so the crystals readily grow into a hexagonal columnar shape under conditions of a low degree of supersaturation.

As for prior art related to zinc oxide particles and films, there has been proposed, for example, an inorganic porous material for supporting zinc oxide or another such photocatalyst, in which at least 80% of the porous portion of the inorganic porous material has a pore size of at least 50 μm, the average pore size is at least 120 μm, and the porosity is at least 46% (Patent Document 1). However, compared to such inorganic porous materials, when zinc oxide particles are applied as a device material, it is necessary to raise the specific surface area by making the pores tinier.

A process in which a zinc oxide film is formed on an electroconductive base by electrodeposition from an aqueous solution (Patent Document 2) has been proposed as a process for forming a zinc oxide film to be used in a solar cell, but no increase in specific surface area has been achieved with this type of process for forming a zinc oxide film by electrodeposition.

With another process that has been proposed, in the formation of a porous zinc oxide thin film for a dye-sensitized solar cell, cathode electrolysis is performed by pre-mixing a template compound into electrolyte containing a zinc salt, and a zinc oxide thin film in which said template compound is adsorbed to the interior surface is formed on a substrate (Patent Document 3). This type of process, however, requires an electroconductive substrate, a template compound having anchor groups, and so forth, and the zinc oxide thin film needs to have an even larger specific surface area.

Thus, various techniques related to zinc oxide particles and films as device materials have been proposed in the past, but it was difficult to achieve a high specific surface area with hexagonal columnar particles originating in the manufacture of hexagonal zinc oxide crystals, and with particles of a similar form. From the standpoint of improving device characteristics, more strategic form design and form control are necessary, which would control the crystal growth of ZnO according to the required characteristics. To further increase the specific surface area from a hexagonal columnar form, it is necessary to create a rougher particle structure or to produce multi-needle crystals. When the crystals are utilized for a sensor or the like, electroconductivity and mechanical strength are also required, but the mechanical strength was not high enough with a zinc oxide wire film or the like. Also, with a microscopic zinc oxide particle film, such as one in which the particle size is only a few dozen nanometers or less, there were too many grain boundaries and adequate electroconductivity was not obtained.

Patent Document 1: Japanese Laid-Open Patent Application Laid-Open No. 2006-75684

Patent Document 2: Japanese Patent Application Laid-Open No. 2000-199097

Patent Document 3: Japanese Patent Application Laid-Open No. 2004-6235

Non-Patent Document 1: M. Law, L. E. Greene, J. C. Johnson, R. Saykally, P. D. Yang, Nature Materials 2005, 4, 455

Non-Patent Document 2: Y. Masuda, N. Kinoshita, F. Sato, K. Koumoto, Crystal Growth & Design 2006, 6, 75

### DISCLOSURE OF THE INVENTION

In light of this situation, the inventors conducted in-depth and painstaking research aimed at developing zinc oxide particles and a zinc oxide particle film having a large specific surface area and which can be used to advantage as a device material, and as a result arrived at the present invention upon discovering that zinc oxide particles and a zinc-containing film having a large specific surface area and a multi-needle shape could be obtained by controlling the growth of zinc oxide crystals. It is an object of the present invention to provide zinc oxide particles and a zinc oxide particle film having a large specific surface area and which are useful as a device material, and to provide a process for producing these.

The present invention for solving the above-mentioned problems is constituted by the following technological means.

(1) Zinc oxide particles, characterized in that the particles are ones formed by crystal growth into a multi-needle shape and have a larger specific surface area than hexagonal columnar particles.

(2) A zinc oxide composite material, characterized by comprising zinc oxide particles that are formed by crystal growth into a multi-needle shape and have a larger specific surface area than hexagonal columnar particles, and a zinc-containing thin film.

(3) A process for producing zinc oxide particles having a larger specific surface area than hexagonal columnar particles, comprising controlling growth of zinc oxide crystals to grow the zinc oxide crystals into a multi-needle shape.

(4) A process for producing a composite material, which comprises a zinc-containing thin film and zinc oxide particles that have a larger specific surface area than hexagonal columnar particles, comprising controlling growth of zinc oxide crystals to growing the zinc oxide crystals into a multi-needle shape.

(5) The process according to (3) above, wherein the zinc oxide crystals are grown into a multi-needle shape by controlling the deposition of zinc oxide crystals from a zinc-containing solution.

(6) The process according to (4) above, which comprises a zinc-containing thin film and zinc oxide particles that have a large specific surface area, comprising controlling the deposition of zinc oxide crystals from a zinc-containing solution to grow the zinc oxide crystals into a multi-needle shape.

(7) The process according to (5) or (6) above, wherein the deposition of zinc oxide crystals is controlled by controlling the degree of supersaturation.

(8) The process according to (5) or (6) above, wherein the form of zinc oxide crystal particles and/or a zinc-containing thin film is controlled by controlling the degree of supersaturation.

(9) The process according to (7) or (8) above, wherein the deposition of anisotropic crystals of the zinc oxide crystals is controlled by a high degree of supersaturation.

(10) The process according to (7) or (8) above, wherein the suppression of growth of zinc oxide crystals is controlled by decreasing the degree of supersaturation.

(11) The process according to (4) above, wherein the deposition of zinc-containing thin film is controlled by a low degree of supersaturation.

The present invention will now be described in further detail.

The present invention is zinc oxide particles, which are formed by crystal growth into a multi-needle shape and have a larger specific surface area than hexagonal columnar particles. The present invention is also a zinc oxide composite material, comprising a zinc-containing thin film and zinc oxide particles that are formed by crystal growth into a multi-needle shape and have a larger specific surface area than hexagonal columnar particles.

The present invention is also a process for producing zinc oxide particles, wherein zinc oxide particles that have a larger specific surface area than hexagonal columnar particles are produced by growing zinc oxide crystals into a multi-needle shape by controlling the growth of the crystals. The present invention is also a process for producing a composite material, wherein the composite material, which comprises a zinc-containing thin film and zinc oxide particles that have a larger specific surface area than hexagonal columnar particles, is produced by growing zinc oxide crystals into a multi-needle shape by controlling the growth of the crystals.

With the present invention, crystals are grown into a multi-needle shape by controlling the growth of zinc oxide crystals, and the term “multi-needle” here means particles in which six or more needle-like particles are clustered at one end. With the present invention, crystals are grown into a multi-needle shape, and the particle surface is given a rougher structure, which increases the specific surface area. It is known that zinc oxide particles growth in a hexagonal columnar shape, but the form of zinc oxide crystals varies with the degree of supersaturation of the zinc-containing solution of the starting raw material. With the present invention, conditions under which zinc oxide is deposited in a hexagonal columnar shape are termed a low degree of supersaturation, and conditions under which zinc oxide that is not in a hexagonal columnar shape is deposited are termed a high degree of supersaturation.

The term “zinc oxide crystal” refers to a substance having a 1:1 zinc:oxygen ratio in hexagonal columnar crystals (wurtzite structure). “Amorphous zinc oxide” refers to a substance having a 1:1 zinc:oxygen ratio and having an amorphous structure with no particular crystal structure. In this Specification, the term “zinc oxide” may refer to zinc oxide crystals, amorphous zinc oxide, or a composite of these. The term “zinc oxide crystal” refers to both zinc oxide single crystals and zinc oxide polycrystals.

In terms of their relation to “growth of multi-needle crystals,” the terms “high degree of supersaturation” and “speeding crystal growth” reflect the hexagonal crystal structure of zinc oxide, and the production of hexagonal columnar particles, since crystal growth is slow under conditions of a low degree of supersaturation. In contrast, crystals can be grown into a multi-needle shape by speeding the crystal growth. To speed the crystal growth, the crystals are grown under conditions of a high degree of supersaturation. If the crystals are grown thoroughly, the form of the needle-like particles will be hexagonal columnar, but particles having a rough structure on the surface of needle-like particles can be formed by halting the crystal growth midway. Examples of ways to halt crystal growth midway include a process in which the needle-like particles are taken out of the reaction system before growing into a hexagonal columnar shape (taking the particles out of the aqueous solution), and a process in which the degree of supersaturation of the solution is lowered to lower the rate of crystal growth.

As for the “zinc-containing thin film,” examples of zinc-containing thin films (thin film sheets) include ZnO crystals, amorphous ZnO, and zinc hydroxide. For example, when heated in the air for 1 hour at 500° C., a zinc-containing thin film becomes particles and a particle film in which these particles are partially linked. These particles can be thought of as zinc oxide crystals. Accordingly, it is possible that the “thin film sheet” prior to heating will include zinc (not be a thin film composed solely of organic components). Also, this reaction system does not include any metal ions other than zinc.

Consequently, the thin film sheet may be a zinc compound of zinc oxide crystals, amorphous zinc oxide, zinc hydroxide, or the like. If the thin film is zinc oxide crystals, there will be no phase transition between and after heating, so it is more likely that the form will be maintained, and in this respect the thin film heat prior to heating can also be considered to be zinc oxide crystals, but the thin film sheets produced in the working examples given below have a thickness of only a few dozen nanometers, so there is the possibility that as heating causes crystal growth and sintering to proceed, the thin film sheet structure cannot be maintained, and will change into the form of particles. Accordingly, there is the possibility that the thin film sheet prior to heating will be zinc oxide crystals. Furthermore, since zinc oxide is synthesized by the pyrolysis of zinc oxalate at 400° C., for example, it is possible that a zinc-containing substance such as amorphous zinc oxide or zinc hydroxide will undergo thorough phase transition into zinc oxide crystals under heating in air for 1 hour at 500° C. as in the working examples.

The most salient feature of the present invention is that the form of the zinc oxide particles and zinc oxide particle film is controlled by controlling the degree of supersaturation. Crystal growth at a high degree of supersaturation greatly changes the form from the hexagonal columnar shape attributable to the zinc oxide crystal structure, allowing multi-needle particles to be synthesized. Zinc oxide particles with a large specific surface area can be synthesized by controlling the degree of supersaturation in the growth of these crystals. Also, zinc oxide particles having a fine, rough structure on their surface can be synthesized by concluding the crystal growth by a sudden lowering of the degree of supersaturation or by removal from the reaction system.

With the present invention, a zinc-containing thin film can be deposited by immersion at a low degree of supersaturation. Also, this zinc-containing thin film can be used to bind zinc oxide particles together, or particles to a substrate. Also, this zinc-containing thin film an be used to increase the mechanical strength of a zinc oxide particle film. Further, this zinc-containing thin film can be used to increase the specific surface area and conductivity of a zinc oxide particle film.

The zinc-containing solution can be the zinc nitrate aqueous solution discussed in the working examples, or it can be a zinc acetate aqueous solution or other such zinc-containing aqueous solution. As long as the reaction system allows zinc oxide to be deposited, it can also be a non-aqueous solution reaction system, such as an organic solution. As long as the reaction system allows zinc oxide to be deposited, a wet heat reaction or the like can also be used. Furthermore, as long as the reaction system allows zinc oxide to be deposited, a vapor phase system, solid phase system, or the like can also be used. Here, the degree of supersaturation can be controlled by adjusting the raw material concentration, temperature, etc.

As will be discussed in the working examples below, when zinc nitrate is used as the raw material, ammonia, urea, substitutes of these, and the like can be used instead of ethylenediamine. Also, the degree of supersaturation can be controlled by varying the temperature, raw material concentration, pH, and so forth, without adding ethylenediamine or the like. The temperature can be set within a range of from above the solidification point of the aqueous solution to below the boiling point (about 0 to 99° C.), according to the raw material concentration, additives, pH, etc. With the present invention, any of various substrates that will not dissolve in the reaction solution, such as those made of metal, ceramic, or a polymer, can be used besides a glass substrate. Also, a particle substrate, fiber substrate, a substrate with a complex shape, or the like can be used besides a flat substrate.

The crystal growth conditions in the process of the present invention will now be described. The temperature can be room temperature, in addition to the 60° C. mentioned in the working examples, but crystal growth proceeds slowly at room temperature. For example, even after one day, the solution will remain transparent, and no zinc oxide particles will be produced, but if enough time is allowed, the zinc oxide will precipitate, and if the raw material concentration, ethylenediamine concentration, and pH are varied, zinc oxide will precipitate in just a few hours even at room temperature.

As to the ethylenediamine concentration, ethylenediamine can be added in an amount of 30 mM or 45 mM, in addition to the 15 mM mentioned in the working examples. At either 15 mM or 30 mM, the production of zinc oxide particles will turn the solution milky, while at 45 mM, the solution will remain clear and no zinc oxide particles will be produced even after one day, but if the temperature, the raw material concentration, and pH are varied, zinc oxide will precipitate in just a few hours even at 45 mM. The concentration of “15 mM” of zinc nitrate hexahydrate and “15 mM” of ethylenediamine here are the molar concentrations (mol/L) of each in the aqueous solution after adjustment.

In the present invention, it is favorable if the concentration of the zinc-containing solution is from 5 to 40 mM and the pH is from 6 to 10, for example. However, these are not limited to these ranges, and can be suitably set to conditions under which zinc oxide will precipitate by adjusting the deposition conditions (raw material, temperature, deposition time, etc.). As shown in FIG. 1, the zinc oxide particles that have undergone crystal growth in a multi-needle shape in the present invention have reduced grain boundaries ((c) and (d) in FIG. 1), are grown with a relief structure ((e) in FIG. 1), and are grown as a thin film ((f) in FIG. 1), and therefore have high conductivity, a large specific surface area, a high strength, making them very useful as a device material.

The particles with a multi-needle shape of the present invention have a particle size of about 1 to 5 μmφ, and the needle crystals that make up these particles with a multi-needle shape consist of clusters of slender needle crystals, in which the side faces of the needle crystals are covered by a cluster of folds. The tips of the needle crystals have a rounded but pointed shape, and are very bumpy. Many hexagonal crystals can be seen at these tip portions, and the lengthwise direction of the needle crystals is the c axis direction, with crystal growth taking place preferentially in the c axis direction.

Also, the zinc oxide particle film has a form in which zinc oxide particles with a multi-needle shape are bound together by a thin film, the thin film has a thickness of 10 to 50 nm and a width of 1 to 10 μm, and the particles are bound tightly together, with no space between the grain boundaries. Thus binding the particles with a thin film increases the mechanical strength of the particle film, and the thin film contributes to higher conductivity and a larger specific surface area. This particle film has continuous open pores whose diameter ranges from a few nanometers to about 10 μm. Also, the particles with a multi-needle shape are preferentially grown anisotropically in the c axis direction. The form of this thin film will change to that of zinc oxide particles or a porous zinc oxide particle film when heated.

The present invention provides the following effects.

(1) The zinc oxide particles of the present invention have a multi-needle shape and have a fine relief structure on the surface of the multi-needle particles, so an advantage is that a larger specific surface area can be obtained than with hexagonal columnar particles or the like.

(2) The zinc oxide particles of the present invention are larger in size than zinc oxide particles of a few dozen nanometers or less, so when a particle film is formed, it will have the specified thickness with fewer grain boundaries, so there is less decrease in conductivity due to grain boundaries (FIG. 1).

(3) With a composite material comprising zinc oxide particles and a zinc-containing thin film, particles with a multi-needle shape afford a larger specific surface area.

(4) Higher mechanical strength can be obtained because the zinc-containing thin film binds the multi-needle particles together and binds the particles to a substrate.

(5) The zinc-containing thin film also contributes to higher conductivity and greater specific surface area.

(6) Because crystal ZnO particles and a particle film can be synthesized at a low temperature, ZnO coatings to paper and the like, and polymer films with lower heat resistance are possible.

(7) Using the zinc oxide particles of the present invention makes it possible to lower cost, reduce weight, and improve flexibility in solar cells and sensors.

### BRIEF DESCRIPTION OF THE DRAWINGS

FIG. 1 consists of diagrams illustrating the concept of controlling the form of zinc oxide particles and a zinc oxide particle film;

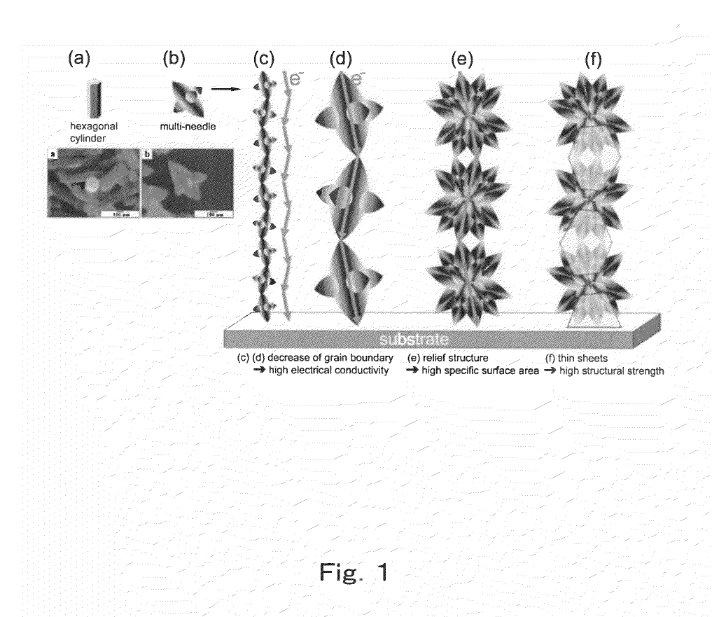

FIG. 2 is a secondary electron micrograph by SEM of zinc oxide particles produced by the process of Working Example 1;

FIG. 3 is a secondary electron micrograph by SEM of zinc oxide particles produced by the process of Working Example 1;

FIG. 4 is a secondary electron micrograph by SEM of zinc oxide particles produced by the process of Working Example 1;

FIG. 5 is an X-ray diffraction pattern of zinc oxide particles produced by the process of Working Example 1;

FIG. 6 is a secondary electron micrograph by SEM of the oxide particle film produced by the process of Working Example 2;

FIG. 7 is a secondary electron micrograph by SEM of the oxide particle film produced by the process of Working Example 2;

FIG. 8 is a secondary electron micrograph by SEM of the oxide particle film produced by the process of Working Example 2; and

FIG. 9 is an X-ray diffraction pattern of zinc oxide particles produced by the process of Working Example 2.

### BEST MODE FOR CARRYING OUT THE INVENTION

The present invention will now be described in specific terms on the basis of working examples.

### Working Example 1

### (1) Production of Multi-Needle Zinc Oxide Particles having Relief Structure on the Surface

15 mM of zinc nitrate hexahydrate was dissolved in 60° C. distilled water, and 15 mM of ethylenediamine was added to the solution to precipitate the ZnO. A glass substrate was tipped into the solution, and the solution was left for 80 minutes at 60° C. without being stirred. The solution turned milky immediately after the addition of the ethylenediamine. The ethylenediamine plays an important role in this reaction system, and the addition of the ethylenediamine causes the ZnO to produce uniform nuclei within the solution, so that ZnO particles are produced, which turns the solution milky. After this, the ZnO particles slowly settled onto the substrate, where crystal growth continued. The settling of the particles that produced uniform nuclei resulted in the solution becoming a pale white after 80 minutes. About 1 hour after the start of the reaction, a high degree of supersaturation was reached in the solution, after which the degree of supersaturation decreased along with a change in the color of the solution.

### (2) Evaluation

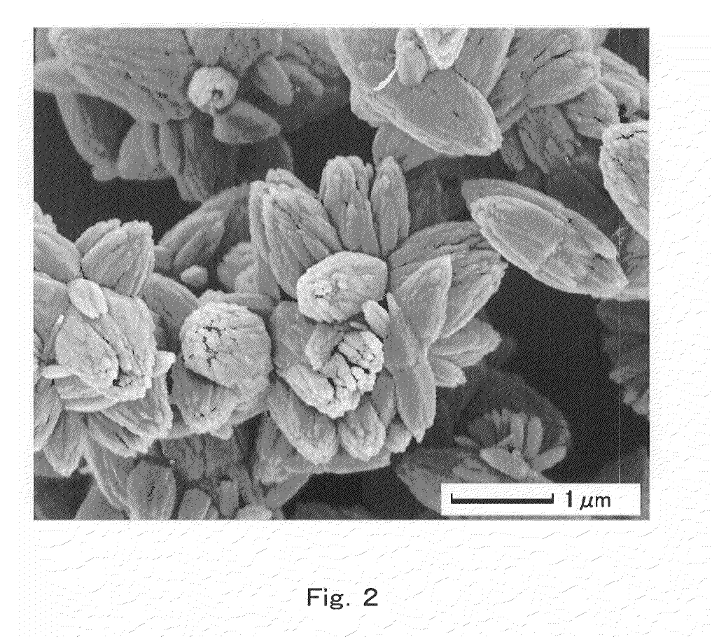

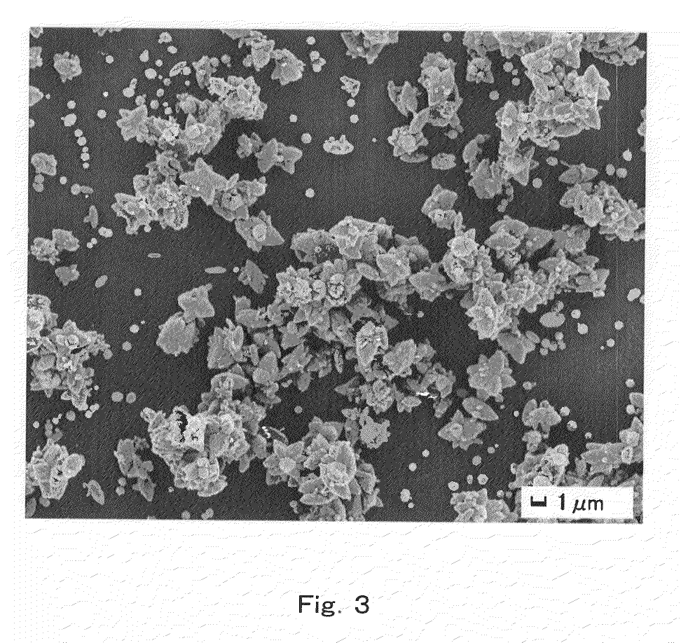

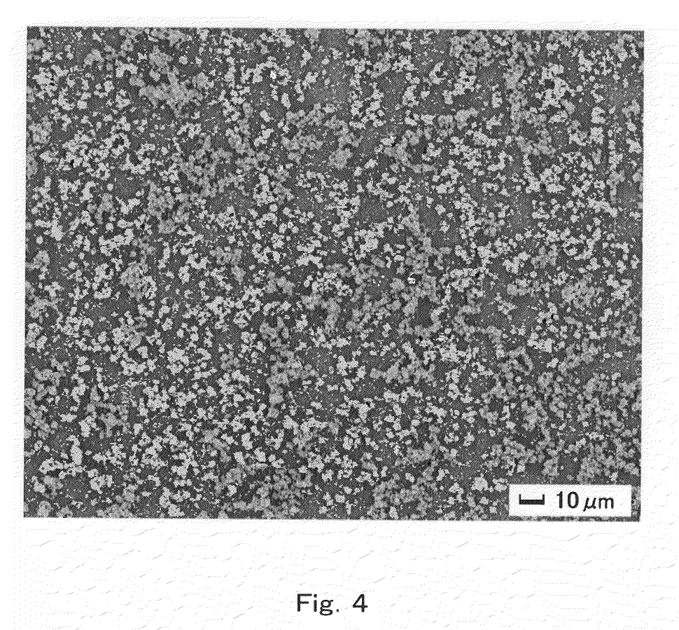

After soaking for 80 minutes, the substrate on which the ZnO particles had been deposited was evaluated by SEM and XRD. The particles had a multi-needle shape in which many needle crystals had grown from the central portion (FIGS. 2 to 4). These particles have more needle crystals than the multi-needle particles discussed in Non-Patent Document 2, which are composed of a few small needle crystals and two large needle crystals. The size of these particles is about 1 to 5 μmφ, which means they are larger than the multi-needle particles discussed in Non-Patent Document 2.

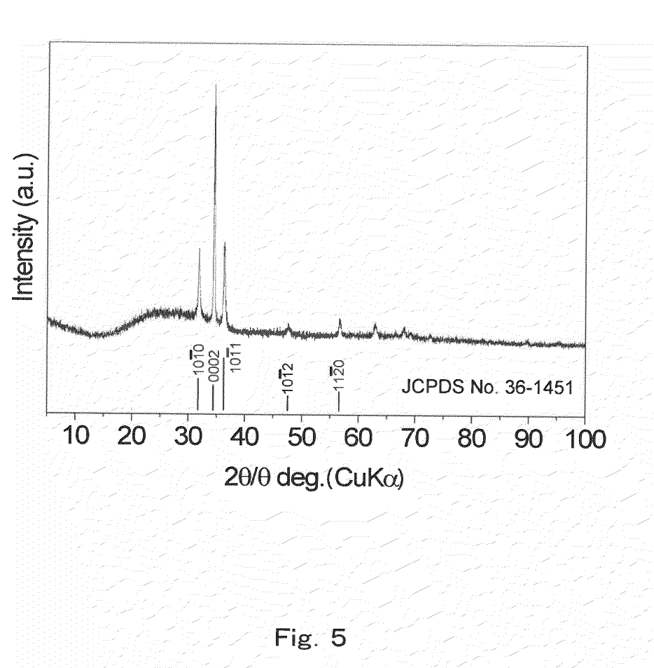

The needle crystals that made up the multi-needle particles were also a cluster of slender needle crystals. Accordingly, the side faces of the needle crystals were covered by a cluster of folds. Also, the tips of the needle crystals had a rounded but pointed shape, and were very bumpy. Many neat hexagonal crystals can be seen at these tip portions, which indicates high crystallinity of ZnO and the direction of the c axis. Hexagonal crystals are the end faces of hexagonal columnar crystals, so it was found that the lengthwise direction of the needle crystals is the c axis direction. The preferential crystal growth in the c axis direction seen by SEM does not contradict the high strength of the 0002 diffraction line in XRD (FIG. 5) (FIGS. 2 to 4).

### Working Example 2

### (1) Production of Composite Material Comprising Zinc-Containing Thin film and Multi-Needle Zinc Oxide Particles on the Surface

A glass substrate was tipped into a 60° C. solution containing 15 mM of zinc nitrate hexahydrate and 15 mM of ethylenediamine, and the solution was held for 6 hours at 60° C. without being stirred, using a water bath. The heating by water bath was then halted, and the solution was allowed to cool naturally for 42 hours. The solution turned milky immediately after the addition of the ethylenediamine, and turned clear again after 6 hours. After 6 hours the bottom part of the reaction vessel was covered with white sediment. The degree of supersaturation in the solution was extremely high for about 1 hour after the start of the reaction, after which it decreased along with a change in the color of the solution.

### (2) Evaluation

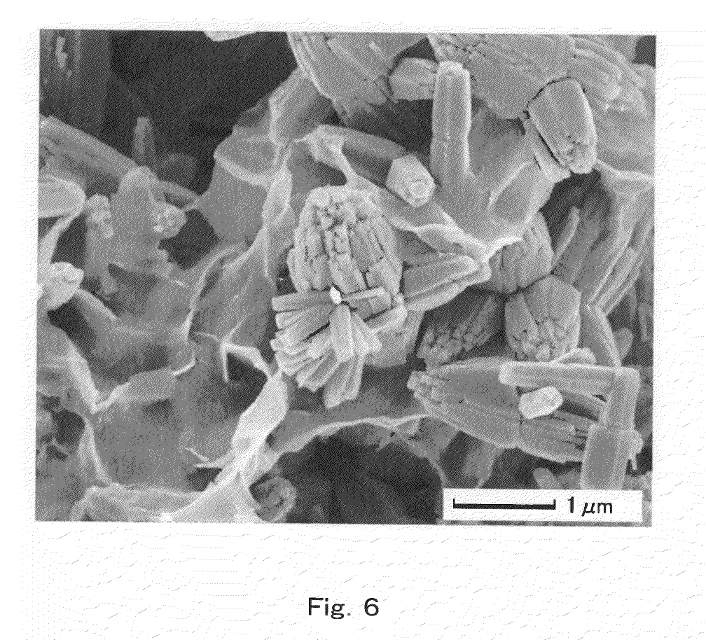

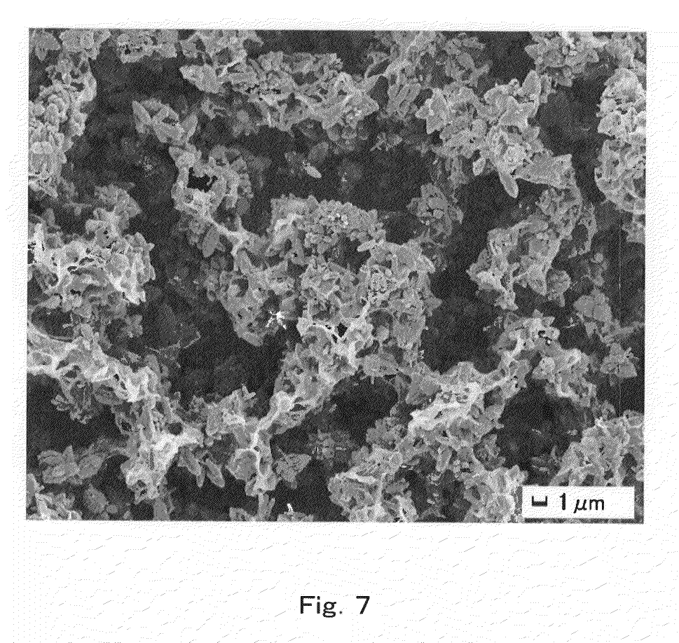

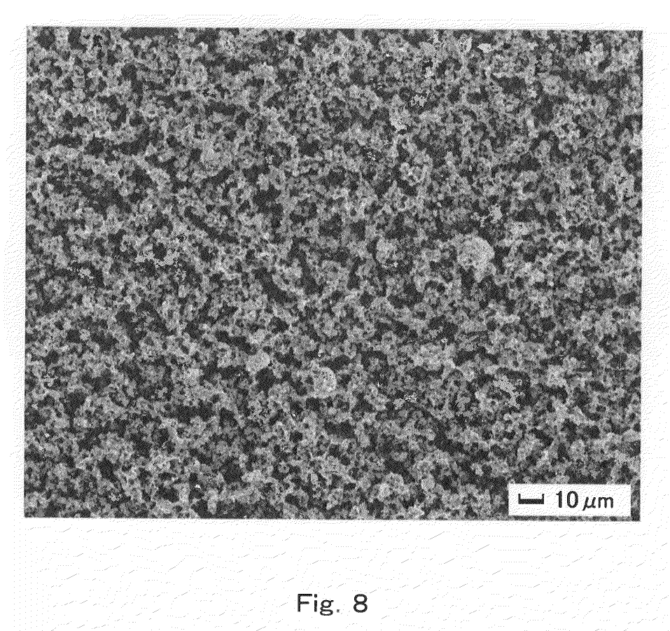

The ZnO particle film thus produced exhibited a form in which multi-needle ZnO particles were bonded together in a thin film (FIGS. 6 to 8). The form of the multi-needle particles was substantially the same as that particles that had soaked for 80 minutes, and both had a large specific surface area. The thin film had a thickness of 10 to 50 nm and a width of 1 to 10 μm, and the particles were bound tightly together, with no space between the grain boundaries. Thus binding the particles with a thin film increases the mechanical strength of the particle film, and the thin film also contributes to higher conductivity and a larger specific surface area.

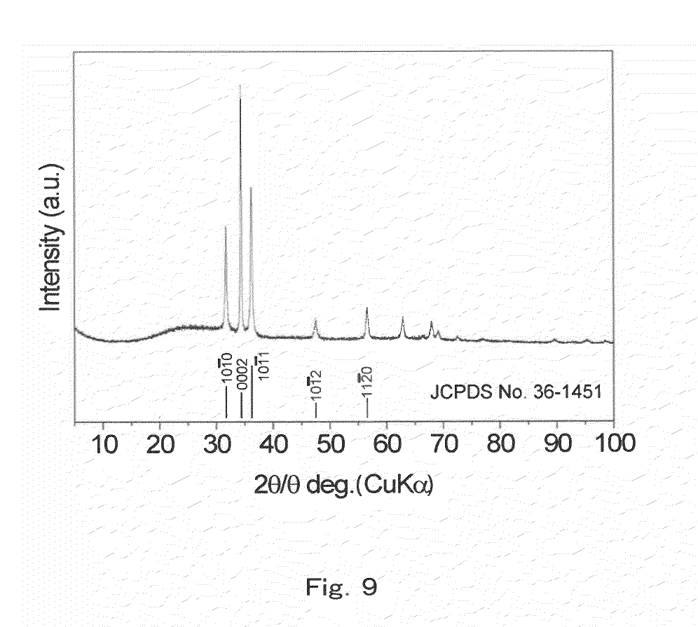

This particle film had continuous open pores whose diameter ranged from a few nanometers to about 10 μm. The XRD pattern of the particle film revealed a diffraction line only for ZnO (FIG. 9). This diffraction line was extremely sharp, indicating high ZnO crystallinity. The intensity of the 0002 diffraction line is believed to be attributable to the preferential anisotropic growth of multi-needle particles in the c axis direction, and an increase in lamination of the (0002) facet.

Crystal growth for the first 80 minutes of the ZnO deposition reaction produced multi-needle ZnO particles having a fine surface structure in a milky solution. Early into the reaction, the ion concentration was high, which means that the degree of supersaturation was high and the crystal growth was fast. After this, the ZnO particles settled, giving a white covering to the bottom of the reaction vessel and turning the solution clear. The ions in the solution were consumed by the crystal growth of the ZnO, and the ion concentration in the solution dropped off quickly. After the production of multi-needle particles, a thin film grew in a transparent solution with a low degree of supersaturation. As a result, a ZnO particle film composed of multi-needle particles and a thin film could be synthesized by the above two-step growth process.

The thin film changed into particles and a particle film when heated in the air for 1 hour at 500° C. This thin film structure was not maintained, and the form changed to particles and a particle film, due to the thinness of the film (only a few dozen nanometers) and/or phase transition. When the XRD evaluation is taken into account, it is believed that the thin film is a zinc-containing thin film such as crystalline ZnO, amorphous ZnO, or zinc hydroxide, and heat treatment results in a change into ZnO particles and a multi-needle ZnO particle film.

### INDUSTRIAL APPLIABILITY

As detailed above, the present invention relates to zinc oxide particles, a zinc oxide particle film, and processes for producing these, and the present invention produces and provides zinc oxide particles with a large specific surface area obtained by crystal growth in a multi-needle shape, and a composite material comprising the zinc oxide particles and a zinc-containing thin film. The large specific surface area zinc oxide particles or composite material thereof of the present invention can be utilized in applications that require a large specific surface area, such as sensors and dye-sensitized solar cells. Also, because the photocatalyst effect is also dependent on the specific surface area, the technique of the present invention for controlling the form of large specific surface area zinc oxide particles can be applied as a technique for controlling the form of photocatalyst materials. Furthermore, the zinc oxide particles of the present invention can also be used in cosmetics and other such products that need particles of various forms, according to the commercial characteristics involved.

1. Zinc oxide particles, characterized in that the particles are ones formed by crystal growth into a multi-needle shape and have a larger specific surface area than hexagonal columnar particles.

2. A zinc oxide composite material, characterized by comprising zinc oxide particles that are formed by crystal growth into a multi-needle shape and have a larger specific surface area than hexagonal columnar particles, and a zinc-containing thin film.

3. A process for producing zinc oxide particles having a larger specific surface area than hexagonal columnar particles, comprising controlling growth of zinc oxide crystals to grow the zinc oxide crystals into a multi-needle shape.

4. A process for producing a composite material, which comprises a zinc-containing thin film and zinc oxide particles that have a larger specific surface area than hexagonal columnar particles, comprising controlling growth of zinc oxide crystals to growing the zinc oxide crystals into a multi-needle shape.

5. The process according to claim 3, wherein the zinc oxide crystals are grown into a multi-needle shape by controlling the deposition of zinc oxide crystals from a zinc-containing solution.

6. The process according to claim 4, which comprises a zinc-containing thin film and zinc oxide particles that have a large specific surface area, comprising controlling the deposition of zinc oxide crystals from a zinc-containing solution to grow the zinc oxide crystals into a multi-needle shape.

7. The process according to claim 5 or 6, wherein the deposition of zinc oxide crystals is controlled by controlling the degree of supersaturation.

8. The process according to claim 5 or 6, wherein the form of zinc oxide crystal particles and/or a zinc-containing thin film is controlled by controlling the degree of supersaturation.

9. The process according to claim 7 or 8, wherein the deposition of anisotropic crystals of the zinc oxide crystals is controlled by a high degree of supersaturation.

10. The process according to claim 7 or 8, wherein the suppression of growth of zinc oxide crystals is controlled by decreasing the degree of supersaturation.

11. The process according to claim 4, wherein the deposition of zinc-containing thin film is controlled by a low degree of supersaturation.
